(19) United States
(12) Patent Application Publication
(10) Pub. No.: US 2013/0076940 A1
(43) Pub. Date: Mar. 28, 2013

(54) PHOTOGRAPHING APPARATUS AND METHOD OF DETECTING DISTORTION THEREOF

(71) Applicant: Makoto KIMURA, Kanagawa Prefecture (JP)

(72) Inventor: Makoto KIMURA, Kanagawa Prefecture (JP)

(73) Assignee: Samsung Electronics Co., Ltd, Suwon-si (KR)

(21) Appl. No.: 13/615,678

(22) Filed: Sep. 14, 2012

(30) Foreign Application Priority Data
Sep. 27, 2011 (JP) 2011-210411
Aug. 9, 2012 (KR) 10-2012-0087367

(51) Int. Cl. H04N 5/228

(52) U.S. Cl. 348/229.1; 348/E05.031

(57) ABSTRACT

A photographing apparatus which includes an exposure control unit that controls exposure regions of an imaging device in units of at least one line, and a distortion detection unit that detects distortion of a photographed image through comparison of a plurality of image signals read from the exposure regions that are adjacent to each other, wherein the exposure control unit controls positions of the exposure regions so that the exposure regions that are continuously exposed are not adjacent to each other with respect to a part or overall of an exposure surface of the imaging device.

### CROSS-REFERENCE TO RELATED APPLICATIONS

This application claims priorities under 35 U.S.C. §119(a) to Japanese Patent Application No. 2011-210411, filed on Sep. 27, 2011, and Korean Patent Application No. 10-2012-0087367, filed on Aug. 9, 2012, in the Korean Intellectual Property Office, the disclosures of which are incorporated herein by reference in their entirety.

### BACKGROUND OF THE INVENTION

1. Field of the Invention

The present disclosure relates to a photographing apparatus and a method of detecting distortion thereof, and more particularly, to a photographing apparatus and a method of detecting distortion thereof, which can detect and correct distortion of a photographed image.

2. Description of the Related Art

Recently, CMOS image sensors that have a small number of wirings and low power consumption in comparison to CCD image sensors have been more widely used. However, in the case of an electronic shutter of the CMOS image sensor, it is technically difficult to realize a global shutter that simultaneously photographs the overall pixels, and thus a focal plane shutter method that photographs an object at a shutter timing that slightly runs off every line has been adopted. In the case of the focal plane shutter method, the photographing time differs for each line, and thus if an object that has no movement is photographed as a still image, distortion (so-called focal plane shutter distortion) of the photographed images occurs due to the difference in photographing time between the photographed images.

Inventions attempting to correct such distortion are disclosed in Japanese Unexamined Patent Publication No. 2011-30065 and Japanese Unexamined Patent Publication No. 2009-182527. However, even if the above-described inventions have been adopted, it is difficult to discriminate whether an object itself has already been distorted, or distortion has occurred due to the operation of an electronic shutter, such as a focal plane shutter distortion. In particular, it is quite difficult to accurately determine the type of such distortion from one sheet of a photographed image.

Accordingly, in the case where a photographing apparatus having a distortion correction function photographs an object that is actually distorted, an image that is different from the actual object may be created due to the false distortion detection and the correction thereof.

### SUMMARY OF THE INVENTION

The present disclosure addresses at least the above problems and/or disadvantages and provides at least the advantages described below. Accordingly, embodiments of the present disclosure provide a photographing apparatus and a method of detecting distortion thereof, which can detect the distortion from one sheet of a photographed image more accurately.

Additional features and utilities of the present general inventive concept will be set forth in part in the description which follows and, in part, will be obvious from the description, or may be learned by practice of the general inventive concept.

Exemplary embodiments of the present disclosure provide a photographing apparatus which includes an exposure control means for controlling exposure regions of an imaging device in the unit of at least one line; and a distortion detection means for detecting distortion of a photographed image through comparison of a plurality of image signals read from the exposure regions that are adjacent to each other, wherein the exposure control means controls positions of the exposure regions so that the exposure regions that are continuously exposed are not adjacent to each other with respect to a part or overall of an exposure surface of the imaging device. According to this configuration, since if the distortion occurs due to hand shaking or movement of the object, a pattern obtained through connection of corresponding points of the plurality of image signals becomes uneven, while if an originally distorted object is photographed, a smooth pattern is obtained, it becomes possible to accurately detect the distortion that has occurred due to the hand shaking or the movement of the object during the photographing. Further, it becomes possible to detect the distortion from one sheet of photographed image.

The exposure control means may control the positions of the exposure regions by alternately selecting the exposure region that is near to an upper end of the exposure surface of the imaging device and the exposure region that is near to a lower end of the corresponding exposure surface so that positive and negative signs of time deviations are sequentially reversed in the case of comparing the time deviations between the adjacent exposure regions in order from the upper end or lower end of the exposure surface of the imaging device. Through the above-described configuration, in the case where the distortion occurs due to the hand shaking or the movement of the object, the unevenness of the pattern appears clearly, and the accuracy of the distortion detection is improved.

Further, the exposure control means may sequentially select random positions of the exposure surface of the imaging device and set the selected positions as the positions of the exposure regions. Through the above-described configuration, in the case where the distortion occurs due to the hand shaking or the movement of the object, the unevenness of the pattern appears clearly, and the accuracy of the distortion detection is improved.

The photographing apparatus may further include a distortion correction means for correcting the distortion of the photographed image if the distortion of the photographed image is detected by the distortion detection means. Through the above-described configuration, the originally distorted object is prevented from being distortion-corrected.

Further, the distortion detection means may detect the distortion of the photographed image through comparison of the plurality of image signals read from the exposure regions with respect to the part of the exposure surface of the imaging device, and the distortion correction means may not correct the distortion of the photographed image if the distortion of the photographed image is not detected by the distortion detection means with respect to the part of the exposure surface of the imaging device. Through the above-described configuration, a processing load that is required to detect the distortion is decreased in comparison to a case where the distortion detection is performed with respect to the entire image surface.

The distortion detection means may detect the corresponding points included in the image signal, and if the pattern obtained through connection of the corresponding points with respect to the plurality of image signals is a locally continuous uneven shape, the distortion detection means may determine that the distortion has occurred in the photographed image. Through the above-described configuration, it becomes possible to accurately detect the distortion that has occurred due to the hand shaking or the movement of the object during the photographing.

Exemplary embodiments of the present disclosure also provide a method of detecting distortion which includes reading a plurality of image signals from a plurality of exposure regions of an imaging device while controlling the exposure regions in the unit of at least one line; and detecting distortion of a photographed image through comparison of the plurality of image signals read from the plurality of exposure regions that are adjacent to each other, wherein the reading step controls positions of the exposure regions so that the exposure regions that are continuously exposed are not adjacent to each other with respect to a part or overall of an exposure surface of the imaging device. According to this method, since if the distortion occurs due to hand shaking or movement of the object, a pattern obtained through connection of corresponding points of the plurality of image signals becomes uneven, while if an originally distorted object is photographed, a smooth pattern is obtained, it becomes possible to accurately detect the distortion that has occurred due to the hand shaking or the movement of the object during the photographing. Further, it becomes possible to detect the distortion from one sheet of photographed image.

Exemplary embodiments of the present disclosure also provide a photographing apparatus, comprising: an imaging device to control an order of exposure regions thereof by lines; and an image signal processing unit to estimate the existence or non-existence of shutter distortion by detecting an uneven pattern of the lines.

In an exemplary embodiment, the control of the order of exposure regions by lines is random.

In an exemplary embodiment, the image signal processing unit comprises: a distortion estimation unit to estimate the existence or non-existence of shutter distortion by detecting an uneven pattern of the lines; and a distortion correction unit to perform distortion correction by correcting the positions of the images for respective lines based on the detected uneven pattern.

In an exemplary embodiment, the distortion estimation unit detects an uneven pattern of the lines by detecting corresponding points of the lines such that distortion is estimated to occur if a degree of unevenness of a trace that connects the corresponding points of the respective lines is high; and the distortion correction unit performs distortion correction by correcting the positions of the images for respective lines as much as the degree of distortion estimated.

Exemplary embodiments of the present disclosure also provide a method of correcting distortion of a photographing apparatus, the method comprising: controlling an order of exposure regions of an imaging device by lines; and estimating the existence or non-existence of shutter distortion of the photographing device by detecting an uneven pattern of the lines.

In an exemplary embodiment, the controlling of the order of exposure regions by lines is random such that the lines of the imaging device are not exposed sequentially.

In an exemplary embodiment, the method further comprises performing distortion correction by correcting the positions of the images for respective lines based on the detected uneven pattern.

In an exemplary embodiment, the detecting an uneven pattern of the lines is performed by detecting corresponding points of the lines such that distortion is estimated to occur if a degree of unevenness of a trace that connects the corresponding points of the respective lines is high; and the distortion correction unit performs distortion correction by correcting the positions of the images for respective lines as much as the degree of distortion estimated.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating the configuration of a photographing apparatus according to an embodiment of the present disclosure;

FIG. 2 is a flowchart illustrating a method of detecting distortion according to an embodiment of the present disclosure;

FIG. 3 is a diagram explaining a method of detecting distortion according to an embodiment of the present disclosure;

FIG. 4 is a diagram explaining a method of detecting distortion according to an embodiment of the present disclosure;

FIG. 5 is a diagram explaining a method of detecting distortion according to an embodiment of the present disclosure;

FIG. 6 is a diagram explaining a method of detecting distortion according to an embodiment of the present disclosure;

FIG. 7 is a diagram explaining a method of detecting distortion according to an embodiment of the present disclosure;

FIG. 8 is a diagram explaining a method of detecting distortion according to an embodiment of the present disclosure;

FIG. 9 is a diagram explaining a method of detecting distortion according to an embodiment of the present disclosure; and

FIG. 10 is a block diagram illustrating the configuration of a photographing apparatus according to another embodiment of the present disclosure.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

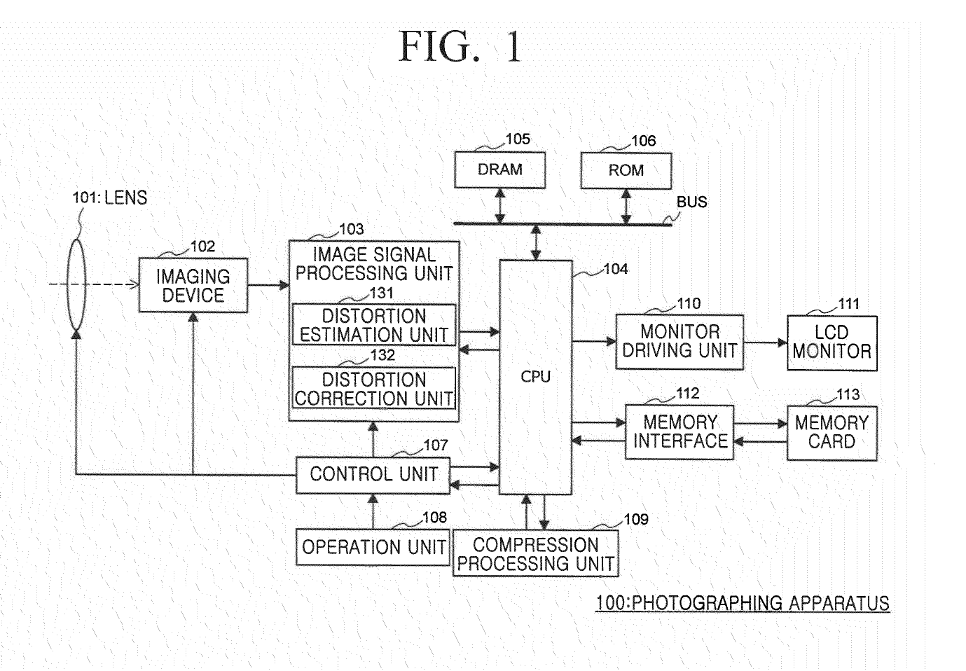

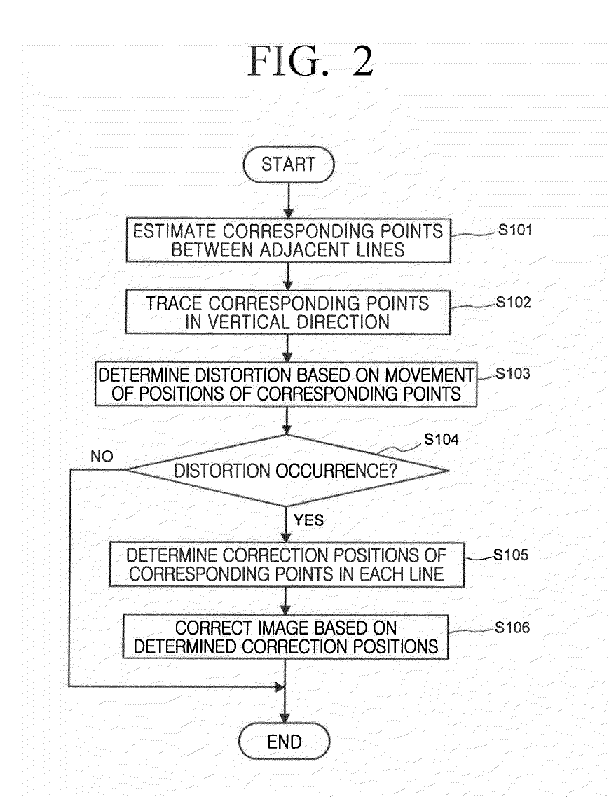

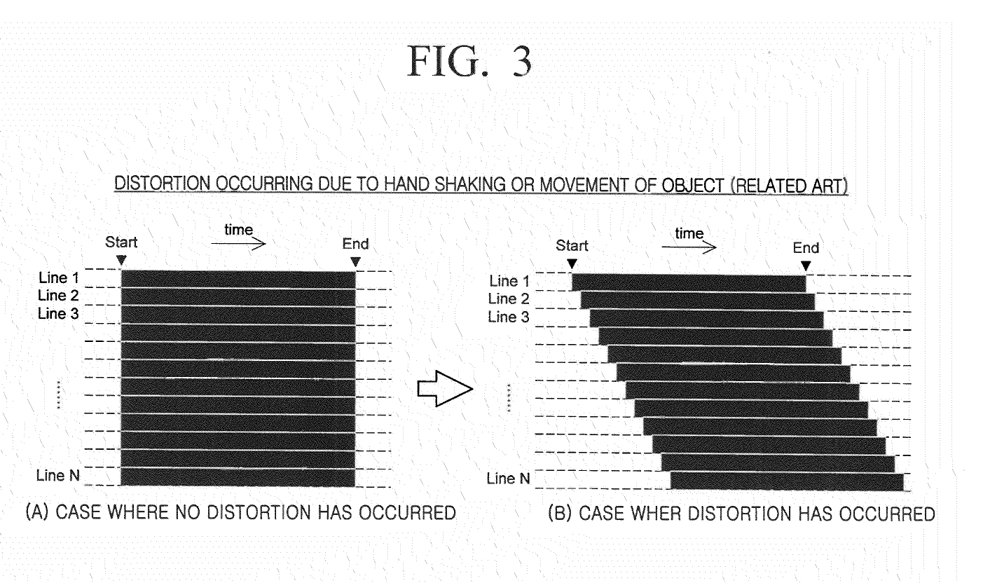

A flow of explanation of embodiments of the present disclosure will be simply described. First, referring to FIG. 1, the configuration of a photographing apparatus 100 according to an embodiment of the present disclosure will be described. Then, referring to FIG. 2, the overall flow of distortion detection processing according to an embodiment of the present disclosure will be described. Further, referring to FIGS. 3 to 9, exposure control and distortion determination will be described in detail.

An exemplary embodiment of the present disclosure relates to a method of detecting distortion of a photographing apparatus 100. In particular, an embodiment of the present disclosure relates to a method of detecting distortion which can accurately detect focal plane shutter distortion from one sheet of a photographed image.

### Configuration of Photographing Apparatus 100

Hereinafter, an exemplary description of a configuration of the photographing apparatus 100 that can realize the method of detecting distortion according to an embodiment of the present disclosure will be described. First, referring to FIG. 1, an overall configuration of the photographing apparatus 100 according to an exemplary embodiment of the present disclosure will be described. FIG. 1 is a block diagram illustrating a configuration of a photographing apparatus 100 according to an exemplary embodiment of the present disclosure. As pointed out above, the overall configuration illustrated in FIG. 1 is exemplary, and partial constituent elements may be omitted, added, or substituted to the extent that the resultant overall configuration performs the intended purposes of the present inventive concept as described herein. The photographing apparatus 100 may be implemented by a digital still camera that can capture a still image, a video camera that can capture a moving image, a portable phone having a photographing function that is equivalent to that of a digital still camera or a video camera, a game machine, an information terminal, a PC, or the like.

As illustrated in FIG. 1, the photographing apparatus 100 includes a lens 101, an image capturing device 102, an image signal processing unit 103, a CPU 104, a DRAM 105, a ROM 106, a control unit 107, an operation unit 108, a compression processing unit 109, a monitor driving unit 110, an LCD monitor 111, a memory interface 112, and a memory card 113. The memory card 113 may be detachably connected to the memory interface 112.

The lens 101 forms a part of an optical system that forms an image of external light information on the imaging device 102, and guides the light from an object to the imaging device 102. The optical system including the lens 101 may include a zoom lens, an iris, a focus lens, or the like. The zoom lens is a lens that changes a viewing angle by way of changing a focal distance. The iris adjusts the quantity of transmitted light. The focus lens moves in a light-axis direction to focus an object image on an image surface. The focus lens can be controlled to be driven by the control unit 107.

The imaging device 102 comprises a plurality of photoelectric conversion devices that convert light incident from the lens 101 into an electrical signal. Each of the photoelectric conversion devices generates the electric signal according to the quantity of received light. In this case, an available imaging device 102 may be a CMOS image sensor. In order to control exposure regions of the imaging device 102, an electronic shutter function is installed in the photographing apparatus. This shutter mechanism can be operated by a user's manipulation of the operation unit 108 (pressing of a shutter button or the like). The operation of the electronic shutter in the imaging device 102 will be described later.

The imaging device 102 is connected to a CDS/AMP circuit (not illustrated). The CDS/AMP circuit is connected to an A/D conversion circuit (not illustrated) or the like. Here, CDS is an abbreviation of correlated double sampling, and AMP is an abbreviation of amplifier. The CDS/AMP circuit removes a reset noise and an AMP noise included in the electrical signal output from the imaging device 102, and amplifies the electrical signal from which the reset noise and the AMP noise have been removed up to a predetermined level. On the other hand, the A/D conversion circuit converts the analog electrical signal output from the CDS/AMP circuit into a digital signal. The digital signal generated by the A/D conversion circuit is input to the image signal processing unit 103.

The image signal processing unit 103 performs distortion detection and distortion correction using the input digital signal. A detailed functional configuration of the image signal processing unit 103 and the distortion detection method will be described later. First, if a digital signal is input, the image signal processing unit 103 performs pre-processing such as pixel defect correction of the imaging device 102, black level correction, and shading correction. The image signal processing unit 103 converts the digital signal before the pre-processing into a luminance signal and a color signal. Further, the image signal processing unit 103 corrects the digital signal based on a white balance control value, a gamma (γ) value, and an edge emphasis control value to generate an image signal.

This image signal is recorded in the DRAM 105 or the memory card 113, or is compression-encoded (for example, JPEG type or MPEG type) by the compression processing unit 109 to be recorded in the memory card 113. Further, wiring of the image signal in the memory card 113 is performed through the memory interface 112. This image signal can be directly displayed on the LCD monitor 111 or displayed on the LCD monitor 111 according to a user's manipulation using the operation unit 108. The display of the image signal on the LCD monitor 111 is performed through the monitor driving unit 110. Here, although the LCD monitor 111 is exemplified as the display means being used, it may be implemented by various alternative display means, such as an organic EL display or the like.

The image signal processing unit 103, the control unit 107, and the compression processing unit 109 operate under the control of the CPU (Central Processor Unit) 104. The CPU 104 is an arithmetic processing device that performs arithmetic processing according to a program stored in the ROM 106 or the like, and functions as a control means for controlling operations of the constituent elements that constitute the photographing apparatus 100. For example, the CPU 104 inputs a control signal to the control unit 107 to drive the focus lens. Further, the CPU 104 may perform operations according to the distortion detection or distortion correction that is performed by the image signal processing unit 103.

Although the memory card 113 is exemplified as the recording means in the above description, this is merely exemplary, and a semiconductor recording medium, a magnetic recording medium, an optical recording medium, and an opto-magnetic recording medium, which are not in the form of a card, may be used to record the image signal.

The operation unit 108 may be composed of up, down, left, and right keys, a power switch, a mode dial, a shutter button, and the like. The shutter button can detect the pressing state such as a half-press, a full-press, and a release. For example, if the shutter button is half-pressed, a focus control starts, and release of the half-press terminates the focus control. Further, if the shutter button is full-pressed, the photographing starts.

### Regarding Operation of Electronic Shutter

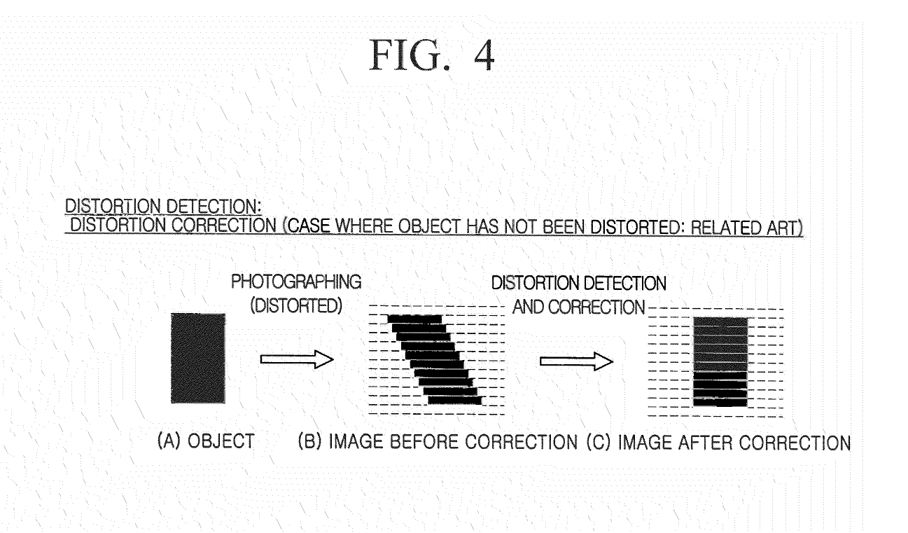

In general, the focal plane shutter type electronic shutter operates to press the shutter by lines in order from the upper portion of the image surface. Through this, as illustrated in FIG. 3, distortion occurs in the image due to a hand shaking or a movement of the object during the photographing operation. In the case of photographing with the focal plane shutter type electronic shutter, in order to obtain the photographed image with no distortion, it is required to use a physical shutter in combination or to correct the distortion through the image processing as illustrated in FIG. 4. In particular, in the case of correcting the distortion through the image processing, a technology to detect the distortion is required.

As an existing distortion detection technology, a technology to sequentially photograph a plurality of images and to detect the distortion through detection of positional deviation of corresponding pixels between the images is known. For example, if uniform positional deviation occurs in the overall image, it may be determined that the photographing apparatus itself moves due to the influence of the hand shaking or the like. Further, if local positional deviation occurs in a part of the image, it may be determined that the object moves. As described above, technologies to detect the distortion or to correct the distortion through estimation of the amount of distortion are known.

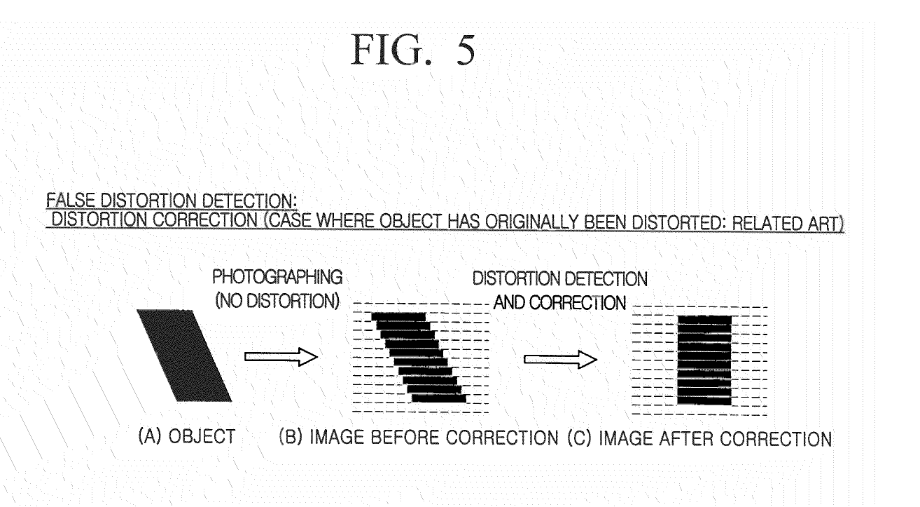

However, even if the existing technologies are used, it is difficult to determine whether the object itself has already been distorted or the distortion has occurred due to the hand shaking or the movement of the object from one sheet of a photographed image. Accordingly, in the case of photographing the distorted object, as illustrated in FIG. 5, the false distortion detection and the correction thereof may be performed.

According to an embodiment of the present disclosure, even in the case of using the focal plane shutter type electronic shutter, it becomes possible to discriminate whether the distorted object has been photographed or the distortion has occurred due to the hand shaking or the movement of the object. Here, the operation of the electronic shutter according to an embodiment of the present disclosure will be described. The operation of the electronic shutter is controlled by the control unit 107.

As described above, in the case of using the CMOS image sensor or the like, it is not possible to simultaneously operate the electronic shutter with respect to all the pixels, but it is relatively easy to control the order of shutter pressing. The reason why it is difficult to discriminate between “an image distorted due to a movement” and “an image obtained by photographing a distorted object” from one sheet of a photographed image is because of the fact that the distortion occurs smoothly. In other words, the reason is because the timing of shutter pressing is in the order of lines.

Accordingly, a method in which an order of shutter pressing (scanning order) is different from the order of line arrangement that is the order from the upper portion of the image surface is provided. When this method is applied, a clear difference between the distorted image and the “image obtained by photographing the distorted object” is illustrated, and the degree of distortion can be easily estimated.

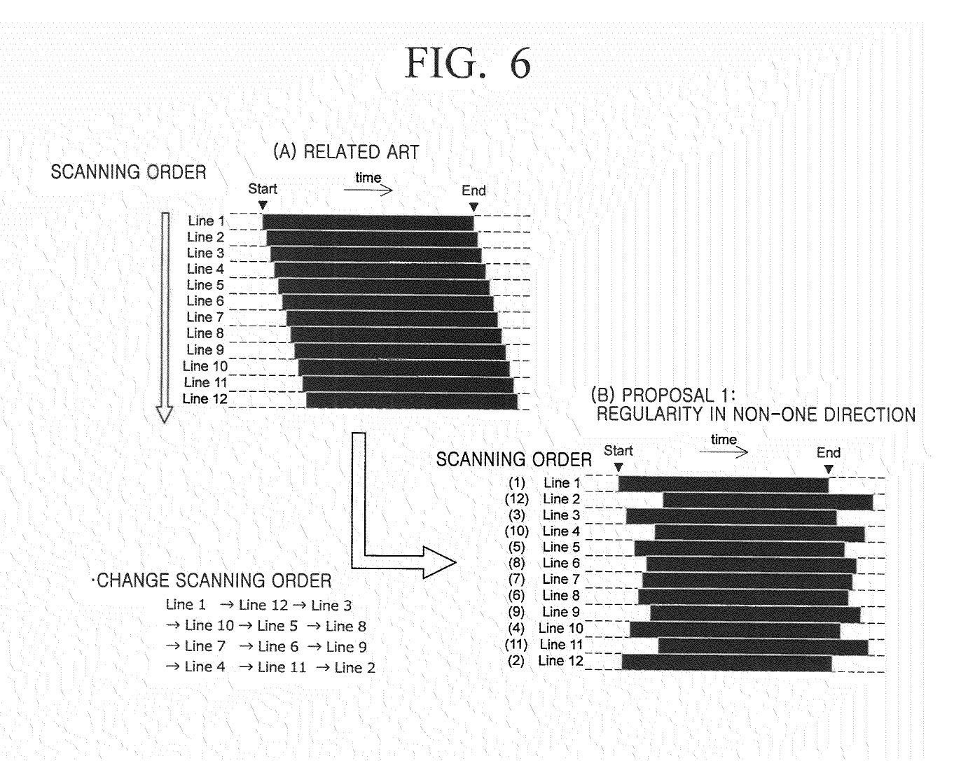

According to the related art as shown as (A) in FIG. 6, since the shutter is pressed in the order of Line 1≦Line 2→ . . . →Line 12 from the upper potion, the time deviation between Line 1 and Line 2, the time deviation between Line 2 and Line 3, . . . , and the time deviation between Line 11 and Line 12 are equal to each other, and thus it is not possible to discriminate between the “image distorted due to the movement” and the “image obtained by photographing the distorted object” from one sheet of a photographed image.

However, according to the embodiment of the present disclosure as shown as (B) in FIG. 6, since the shutter is alternately pressed in the order of Line 1→Line 12→Line 3→Line . . . Line 10→ . . . →Line 11→Line 2, the temporal sign of the time deviation between Line 2 and Line 3 is reversed with respect to that of the time deviation between Line 1 and Line 2. In the same manner, the sign of the time deviation between Line 2 and Line 3 is reversed with respect to that of the time deviation between Line 3 and Line 4. According to this method, if the hand shaking occurs, a locally uneven pattern appears in addition to the distortion of the overall image. Depending on the existence/nonexistence of this pattern, it becomes possible to discriminate between the “image distorted due to a movement” and the “image obtained by photographing a distorted object” from one sheet of a photographed image.

The above-described effect according to the present embodiment is realized by controlling the timing of shutter pressing so that the time deviations of the adjacent lines (or a group of the plurality of lines) do not become constant.

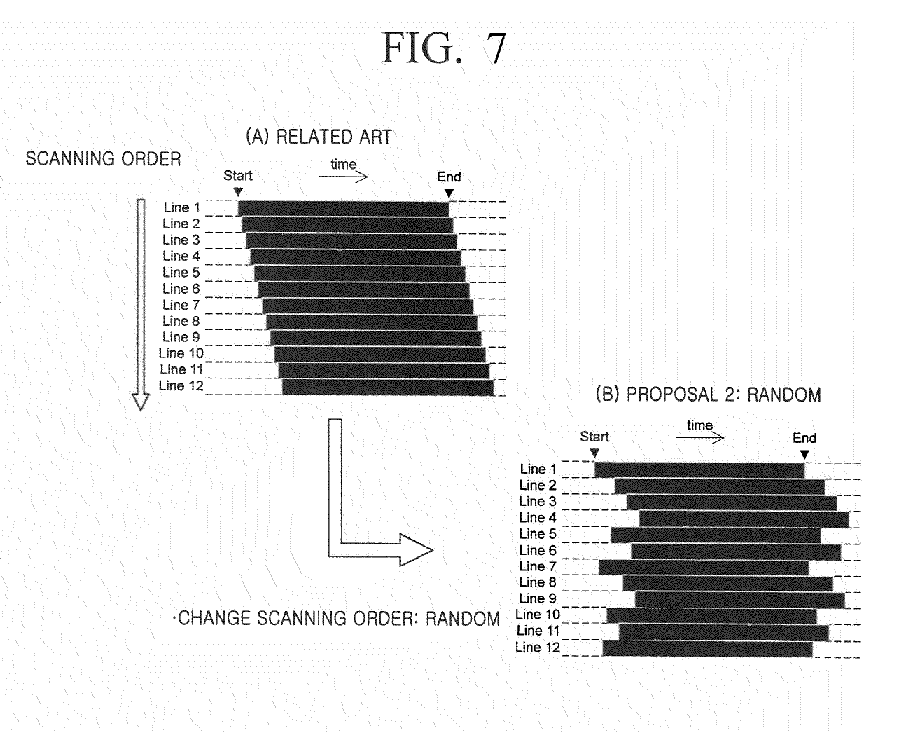

Further, according to another embodiment in which the order of shutter pressing is random as shown as (B) in FIG. 7, if a hand shaking occurs while a photograph is being taken, a locally uneven pattern appears, and depending on the existence/nonexistence of this pattern, it becomes possible to discriminate between the “image distorted due to a movement” (i.e., hand shaking) and the “image obtained by photographing a distorted object” from one sheet of a photographed image.

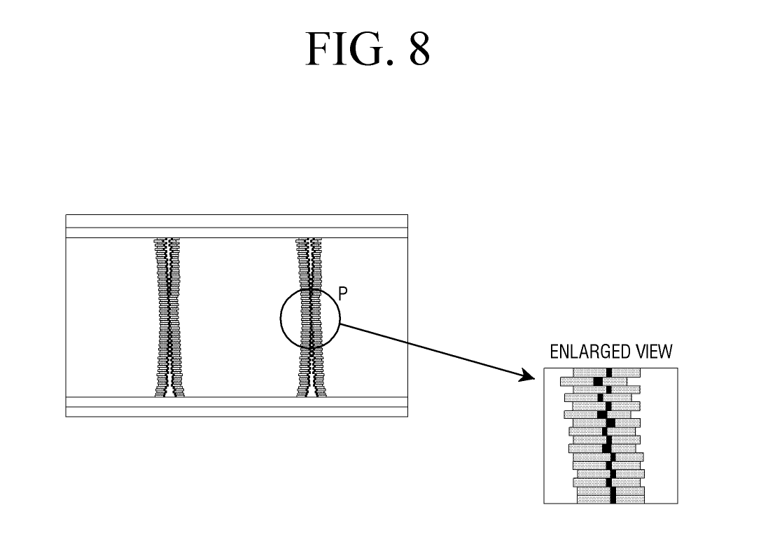

FIG. 8 illustrates the result of experiments to which the embodiment of FIG. 6B has actually been applied. From the result of experiments in FIG. 8, it can be confirmed that the focal plane shutter distortion appears as a local uneven pattern.

As described above, the control unit 107 controls the timing of shutter pressing so that the time deviations of the adjacent lines (or the group of the plurality of lines) do not become constant.

Configuration of Image Signal Processing Unit 103

Here, the configuration of the image signal processing unit 103 will be described in more detail. As shown in FIG. 1, the image signal processing unit 103 includes a distortion estimation unit 131 and a distortion correction unit 132. The distortion estimation unit 131 estimates the existence/nonexistence of the focal plane shutter distortion from one sheet of photographed image, and detects the degree of distortion if the focal plane shutter distortion occurs. The distortion correction unit 132 corrects the distortion of the photographed image if the focal plane shutter distortion is detected by the distortion estimation unit 131.

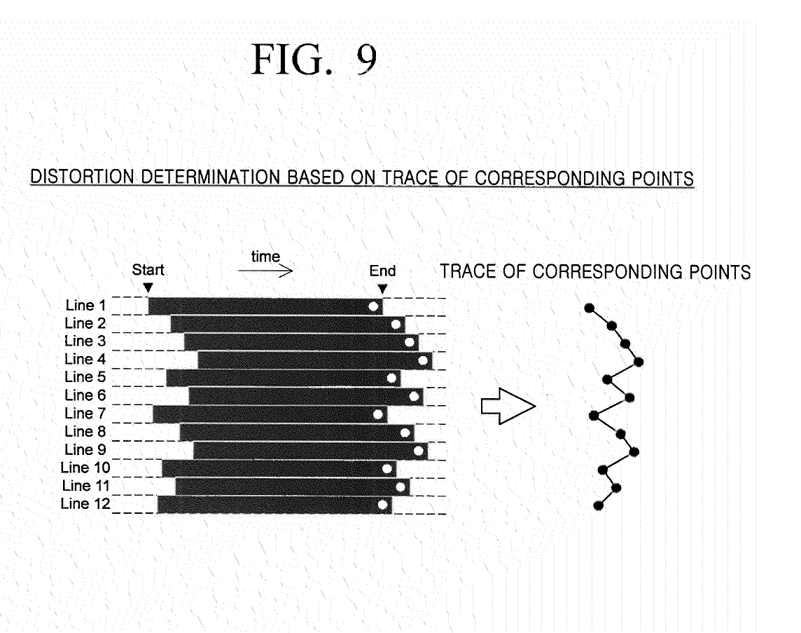

As described above, if the focal plane shutter distortion occurs in the photographed image, an uneven pattern as shown as (B) in FIG. 6 or (B) in FIG. 7 appears. The distortion estimation unit 131 estimates the existence/nonexistence of the focal plane shutter distortion through detection of the uneven pattern. For example, as shown in FIG. 9, the distortion estimation unit 131 detects corresponding points for respective lines, and determines that the focal plane shutter distortion occurs if the degree of unevenness of a trace that connects the corresponding points of the respective lines is high (if the trace is not smooth).

The determination of whether the trace is smooth can be accurately realized by detecting the time deviation between the adjacent lines and detecting whether the positive and negative signs of the time deviations are reversed. Specifically, if the temporal sign is reversed, it is determined that the trace is not smooth, and if the temporal signal is not reversed (or the time deviations are constant), it is determined that the trace is smooth.

If the focal plane shutter distortion is detected, the distortion estimation unit 131 estimates the degree of distortion from the amount of deviation of upper and lower lines. The distortion correction unit 132 performs the distortion correction of the photographed image through correcting the positions of the images for respective lines as much as the degree of distortion estimated by the distortion estimation unit 131.

As the method of correcting the distortion, certain distortion correction technologies that are available at present and in the future may be combined and used.

Method of Detecting Distortion

Hereinafter, referring to FIG. 2, the overall flow of a distortion detection process according to an embodiment of the present disclosure will now be described. FIG. 2 is a flowchart illustrating the overall flow of the distortion detection process according to this embodiment. The distortion detection process illustrated in FIG. 2 may be realized by the operations of the image signal processing unit 103.

As illustrated in FIG. 2, the image signal processing unit 103 first estimates corresponding points between adjacent lines (operation S101). For example, the image signal processing unit 103 detects positions of pixels to be continued, such as parts of the same object, as the corresponding points. The corresponding points may be detected from continuity of edge information that corresponds to the contour of an object or color information. Next, the image signal processing unit 103 performs tracing in the vertical direction of the corresponding points, and recognizes the trace of the corresponding points (see FIG. 9) (operation S102). Next, the image signal processing unit 103 determines the existence/nonexistence of the focal plane shutter distortion based on the movement of the positions of the corresponding points (operation S103).

For example, the image signal processing unit 103 detects the time deviation between the adjacent lines, and confirms whether the reversal of the temporal signs of the time deviations is observed. If the reversal of the temporal signs is observed, the image signal processing unit 103 determines that the focal plane shutter distortion occurs, and if the reversal of the temporal signs is not observed, the image signal processing unit 103 determines that the focal plane shutter distortion does not occur. If it is determined that the focal plane shutter distortion occurs (operation S104), the image signal processing unit 103 proceeds to operation S105. On the other hand, if it is determined that the focal plane shutter distortion does not occur (operation S104), the image signal processing unit 103 then terminates a series of processing according to the distortion correction.

In the case of proceeding to operation S105, the image signal processing unit 103 determines the correction positions of the corresponding points in the respective lines. Then, at operation S106, the image signal processing unit 103 modifies the image based on the correction positions determined in operation S105. After modifying the image, the image signal processing unit 103 terminates the series of processing according to the distortion correction.

As described above, the overall flow of the distortion detection process according to this embodiment has been described.

As described above, since the photographing apparatus 100 according to this embodiment controls the timing of shutter pressing so that the time deviations of the adjacent lines (or a group of the plurality of lines) do not become constant, and performs the distortion detection based on the time deviations between the adjacent lines, it is possible to discriminate between the “image distorted due to a movement” and the “image obtained by photographing a distorted object” from one sheet of a photographed image. As a result, even in the case where a distorted object is photographed, it becomes possible to correctly detect the focal plane shutter distortion. Further, since the distortion can be detected from one sheet of a photographed image, the processing load can be suppressed, and high-speed distortion detection becomes possible.

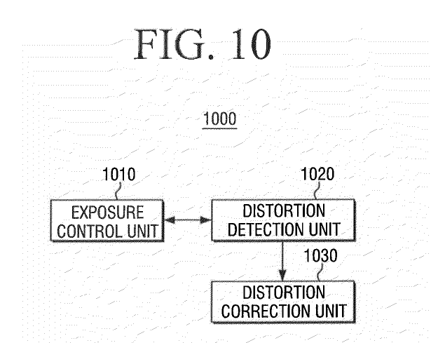

Hereinafter, referring to FIG. 10, a photographing apparatus 1000 for distortion detection according to an embodiment of the present disclosure will be described. As illustrated in FIG. 10, the photographing apparatus 1000 includes an exposure control unit 1010, a distortion detection unit 1020, and a distortion correction unit 1030.

The exposure control unit 1010 can control the exposure regions of the imaging device of the photographing apparatus 1000 in the unit of at least one line.

In particular, the exposure control unit 1010 may control the lines that are near to an upper end of the exposure regions and the lines that are near to a lower end of the exposure regions of the imaging device, among the lines that constitute the part or overall of the exposure regions of the imaging device, to be alternately selected and scanned. Further, as shown at (B) in FIG. 6, the exposure control unit 1010 may control the lines that constitute a part or overall of the exposure regions of the imaging device to be randomly selected and scanned.

In this case, the exposure control unit 1010 may be implemented by a CPU.

The distortion detection unit 120 detects the distortion of the photographed image through comparison of the plurality of image signals for respective lines that constitute a part or overall of the exposure regions of the imaging device. Specifically, the distortion detection unit 120 detects the corresponding points included in the plurality of image signals, and detects whether the photographed image is distorted using the pattern obtained by connecting the corresponding points with respect to the plurality of image signals. For example, as illustrated in FIG. 9, the distortion detection unit 120 may detect that the photographed image is distorted if the pattern obtained through connection of the corresponding points with respect to the plurality of image signals is in an uneven shape.

If the distortion of the photographed image is detected by the distortion detection unit, the distortion correction unit 130 corrects the distortion of the photographed image.

According to the photographing apparatus 1000 as described above, since if the distortion occurs due to a hand shaking during photographing or a movement of an object being photographed, the pattern obtained through connection of the corresponding points of the plurality of image signals becomes uneven, while if the originally distorted object is photographed, the smooth pattern is obtained, it becomes possible to accurately detect the distortion that has occurred due to the hand shaking or the movement of the object during the photographing.

While the present disclosure has been shown and described with reference to certain embodiments thereof, it will be understood by those skilled in the art that various changes in form and detail may be made therein without departing from the spirit and scope of the present disclosure, as defined by the appended claims.

For example, although the configuration that detects the distortion after capturing images with respect to all the lines has been described, a configuration that detects the distortion from the result of image capturing with respect to a part of the lines can also be realized. For example, a high-speed operation may be realized by detecting the distortion from a part of the lines and performing no correction of the distortion if the distortion is not detected. Further, the distortion may be detected from a part of the lines, and if the distortion is detected, the correction of the distortion may start without detecting the distortion any further. Even in this case, the processing time for the distortion detection can be reduced, and thus the high-speed operation can be realized.

What is claimed is:

1. A photographing apparatus comprising:
an exposure control unit to control exposure regions of an imaging device in units of at least one line; and
a distortion detection unit to detect distortion of a photographed image through comparison of a plurality of image signals with respect to lines that constitute a part or overall of the exposure regions of the imaging device,
wherein the exposure control unit controls the lines that constitute the part or overall of the exposure regions of the imaging device to be scanned non-sequentially.

2. The photographing apparatus of claim 1, wherein the exposure control unit controls the lines that are near to an upper end of the exposure regions and the lines that are near to a lower end of the exposure regions, among the lines that constitute the part or overall of the exposure regions of the imaging device, to be alternately selected and scanned.

3. The photographing apparatus of claim 1, wherein the exposure control unit controls the lines that constitute the part or overall of the exposure regions of the imaging device to be randomly selected and scanned.

4. The photographing apparatus of claim 2, wherein the distortion detection unit detects corresponding points included in the plurality of image signals, and detects whether distortion occurs in the photographed image using a pattern obtained by connecting the corresponding points of the plurality of image signals.

5. The photographing apparatus of claim 4, wherein the distortion detection unit detects that the distortion has occurred in the photographed image if the pattern obtained by connecting the corresponding points of the plurality of image signals is in an uneven shape.

6. The photographing apparatus of claim 1, further comprising a distortion correction unit correcting the distortion of the photographed image if the distortion of the photographed image is detected by the distortion detection means.

7. A method of detecting distortion, the method comprising:
reading image signals from exposure regions while controlling the exposure regions of an imaging device in units of at least one line; and
detecting the distortion of a photographed image through comparison of the plurality of image signals with respect to lines that constitute a part or overall of the exposure regions of the imaging device,
wherein the reading operation reads the image signals from the exposure regions while controlling the lines that constitute the part or overall of the exposure regions of the imaging device to be scanned non-sequentially.

8. The method of detecting distortion of claim 7, wherein the reading operation reads the image signals from the exposure regions while controlling the lines that are near to an upper end of the exposure regions and the lines that are near to a lower end of the exposure regions, among the lines that constitute the part or overall of the exposure regions of the imaging device, to be alternately selected and scanned.

9. The method of detecting distortion of claim 7, wherein the reading operation reads the image signals from the exposure regions while controlling the lines that constitute the part or overall of the exposure regions of the imaging device to be randomly selected and scanned.

10. The method of detecting distortion of claim 8, wherein the detecting operation detects corresponding points included in the plurality of image signals, and detects whether distortion occurs in the photographed image using a pattern obtained by connecting the corresponding points of the plurality of image signals.

11. The method of detecting distortion of claim 10, wherein the detecting operation detects that the distortion has occurred in the photographed image if the pattern obtained by connecting the corresponding points of the plurality of image signals is in an uneven shape.

12. The method of detecting distortion of claim 7, further comprising correcting the distortion of the photographed image if the distortion of the photographed image is detected in the detecting operation.

13. A photographing apparatus, comprising:
an imaging device to control an order of exposure regions thereof by lines; and
an image signal processing unit to estimate the existence or non-existence of shutter distortion by detecting an uneven pattern of the lines.

14. The photographing apparatus of claim 13, wherein the control of the order of exposure regions by lines is random.

15. The photographing apparatus of claim 15, wherein the image signal processing unit comprises:
a distortion estimation unit to estimate the existence or non-existence of shutter distortion by detecting an uneven pattern of the lines; and
a distortion correction unit to perform distortion correction by correcting the positions of the images for respective lines based on the detected uneven pattern.

16. The photographing apparatus of claim 15, wherein:
the distortion estimation unit detects an uneven pattern of the lines by detecting corresponding points of the lines such that distortion is estimated to occur if a degree of unevenness of a trace that connects the corresponding points of the respective lines is high; and
the distortion correction unit performs distortion correction by correcting the positions of the images for respective lines as much as the degree of distortion estimated.

17. A method of correcting distortion of a photographing apparatus, the method comprising:
controlling an order of exposure regions of an imaging device by lines; and
estimating the existence or non-existence of shutter distortion of the photographing device by detecting an uneven pattern of the lines.

18. The method of claim 17, wherein the controlling of the order of exposure regions by lines is random such that the lines of the imaging device are not exposed sequentially.

19. The method of claim 17, further comprising:
performing distortion correction by correcting the positions of the images for respective lines based on the detected uneven pattern.

20. The method of claim 17, wherein:
the detecting an uneven pattern of the lines is performed by detecting corresponding points of the lines such that distortion is estimated to occur if a degree of unevenness of a trace that connects the corresponding points of the respective lines is high; and
the distortion correction unit performs distortion correction by correcting the positions of the images for respective lines as much as the degree of distortion estimated.
